(19) United States
(12) Patent Application Publication
(10) Pub. No.: US 2013/0262033 A1
(43) Pub. Date: Oct. 3, 2013

(54) REMOTE MONITORING AND MANAGEMENT OF SUNLESS TANNING DEVICES

(71) Applicant: Greg Henson, Lee's Summit, MO (US)

(72) Inventor: Greg Henson, Lee's Summit, MO (US)

(21) Appl. No.: 13/855,433

(22) Filed: Apr. 2, 2013

Related U.S. Application Data
(60) Provisional application No. 61/619,281, filed on Apr. 2, 2012.

(51) Int. Cl. G06Q 30/00

(52) U.S. Cl. CPC G06Q 30/01
USPC 702/183; 702/182

(57) ABSTRACT

A system is provided for monitoring a sunless tanning device or numerous sunless tanning devices within a single or multiple facilities. The system includes monitoring devices within the sunless tanning devices for collecting and relaying usage and diagnostic information. The system also includes a communications interface for receiving and transmitting data transmissions from the sunless device to a central supervisory monitoring location. A related method is also provided for determining and responding to occurrences of an event associated with an alarm trigger, the usage of the sunless tanning device on a real time or set time bases, or general update or changes to operational parameters.

### RELATED APPLICATIONS

This application relates to and claims priority to U.S. Provisional Patent Application No. 61/619,281, which was filed Apr. 2, 2012 and is incorporated herein by reference in its entirety.

### BACKGROUND OF THE INVENTION

Several industries manufacture and distribute devices, products, and/or consumables to a large number of clients, such as stores, salons, and other businesses. These industries may also provide their clients with a variety of services associated with their devices, products, and/or consumables. However, as these industries grow and the number of client increase, it is often difficult to efficiently manage client services in accordance with the needs of each of the clients. For example, tracking and managing client billing information, payment information, and product and consumable status information is a challenge in such industries. Further, many industries distribute devices that use consumables. Clients submit warranty or service requests for these devices for a variety of reasons. However, until a representative travels to the client and examines the device in the field or until the client returns the device, many of these industries are unable to determine what may have caused the client's problem. Further, it is often difficult to discern between a problem caused by a warranty related issue and a problem resulting from client mishandling. Accordingly, it is a challenge to manage client services and meet client needs in industries having a large number of clients.

### SUMMARY OF THE INVENTION

Implementations described and claimed herein address the foregoing problems by providing a system and method for remotely monitoring and managing client devices and consumables. In an exemplary implementation, the system and method for remote monitoring and management is used in the sunless tanning industry.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for remotely monitoring and managing sunless tanning devices.

FIG. 2 illustrates components of an example sunless tanning device that may be remotely monitored and managed.

FIG. 3 illustrates additional components of the example sunless tanning device that may be remotely monitored and managed.

FIG. 4 illustrates additional components of the example sunless tanning device that may be remotely monitored and managed.

FIG. 5 illustrates an example network environment that may be useful in implementing the presently disclosed technology.

FIG. 6 illustrates an example computing system that may be useful in implementing the presently disclosed technology.

### DETAILED DESCRIPTION

Aspects of the presently disclosed technology involve remote monitoring and management of client devices and consumables for industries with a large number of clients. One such industry is the sunless tanning industry. However, it will be understood by those of ordinary skill in the art that the presently disclosed technology may be implemented in a variety of industries and contexts.

Sunless tanning, also known as artificial tanning, UV-free tanning, airbrush tanning, or spray tanning, is becoming increasingly popular. Clients, including, but not limited to, salons, fitness centers, spas, resorts, and individuals, obtain one or more sunless tanning devices and associated consumables from a manufacturer and/or distributor. One example of such consumables is a chemical composition that the sunless tanning device deposits over all or a portion of a human body. The chemical composition may be, for example, a skin darkener, a skin lightener, a skin bleacher, a skin toner, a bronzer, other colorants, a moisturizer, a sunscreen or suntan lotion, a sun-burn or other burn treatment, a wrinkle, fine-line, or other anti-aging treatment, a tanning accelerant, a skin treatment, a cosmetic, an insect repellant, an anti-microbial, an exfoliant, a nutriment or vitamin, a massage aid, a muscle relaxant, a decontamination agent, or some combination of them. However, other chemical compositions that may be applied to part or all of the human body are contemplated. For example, the chemical composition may further include one or more additives, including, without limitation, a preservative, a thickener, a solvent, an emulsifier, a fragrance, a stabilizer, a surfactant, a pH adjuster, an anti-caking agent, or some combination of them. Sunless tanning devices generally atomize (e.g., aerosolize, nebulize, or generate mist, fog, or spray) the chemical composition and deposit it on the skin using one or more nozzles over one or more sprays.

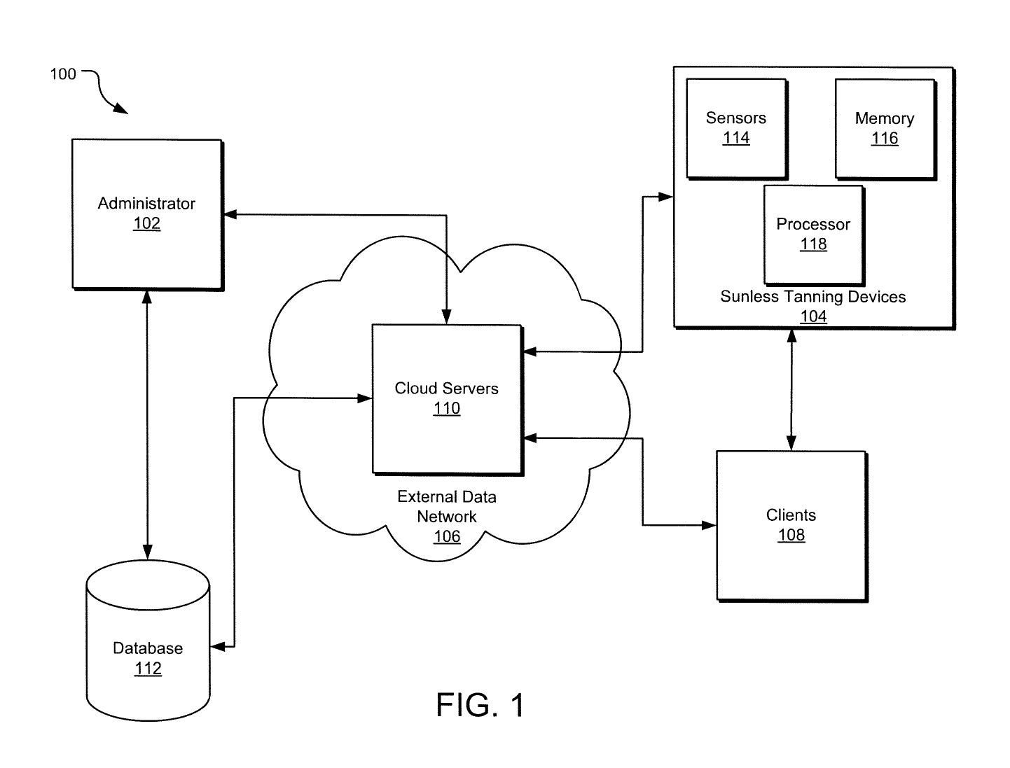

Many clients are businesses that have multiple sunless tanning devices for use by customers of those clients. A distributor provides a client with sunless tanning devices and associated consumables. Often, the client pays the distributor for use of the sunless tanning devices, and the client then charges its customers for each use. The distributor additionally supplies the client with replacement consumables, as needed, and with warranty, repair, and/or maintenance services relating to the sunless tanning devices. However, as the number of clients grows, it becomes difficult for a distributor to track and manage client billing and payment information relating to the use of the sunless tanning devices. Further, it is challenging for a distributor to track and manage the status of a client's consumables, such as when the client needs replacement consumables. Finally, if a client experiences a problem with one of its sunless tanning devices, the client will often submit a warranty, repair, or maintenance request to the distributor. However, until a representative of the distributor directly examines the sunless tanning device, the distributor is generally unable to determine what may have caused the client's problem. Similarly, it is often difficult to discern between a problem caused by a warranty related issue and a problem resulting from client mishandling. Accordingly, an example system 100, as described with respect to FIG. 1, is provided for remotely monitoring and managing sunless tanning devices.

In one implementation, the system 100 includes an administrator 102, such as the distributor, that remotely monitors and manages one or more sunless tanning devices 104 and one or more clients 108 via an external data network 106. The sunless tanning devices 104 and the clients 108 may be connected to the administrator 102 via one or more cloud servers 122 within the external data network 106. Connection via the cloud servers 122 allows a greater number of sunless tanning devices 104 and clients 108 to connect to the administrator 102 at any physical distance.

The system 100 may utilize one or more databases (e.g., a database 112) to store information relating to the administrator 102, the sunless tanning devices 104, and the clients 108. The administrator 102 and/or the clients 108 may be directly connected to the database 112 or indirectly connected via the cloud servers 110. In one implementation, the administrator 102 and the clients 108 have access to the database 112 to read, add, delete, and/or modify information stored within the database 112. In some implementations, only the administrator 102 has add/modify/delete access, and the clients 108 have read-only access. In other implementations, only the administrator 102 has access to the database 112. Where the clients 108 are granted access to the database 112, the administrator 102 may restrict and/or otherwise modify the information the clients 108 can access.

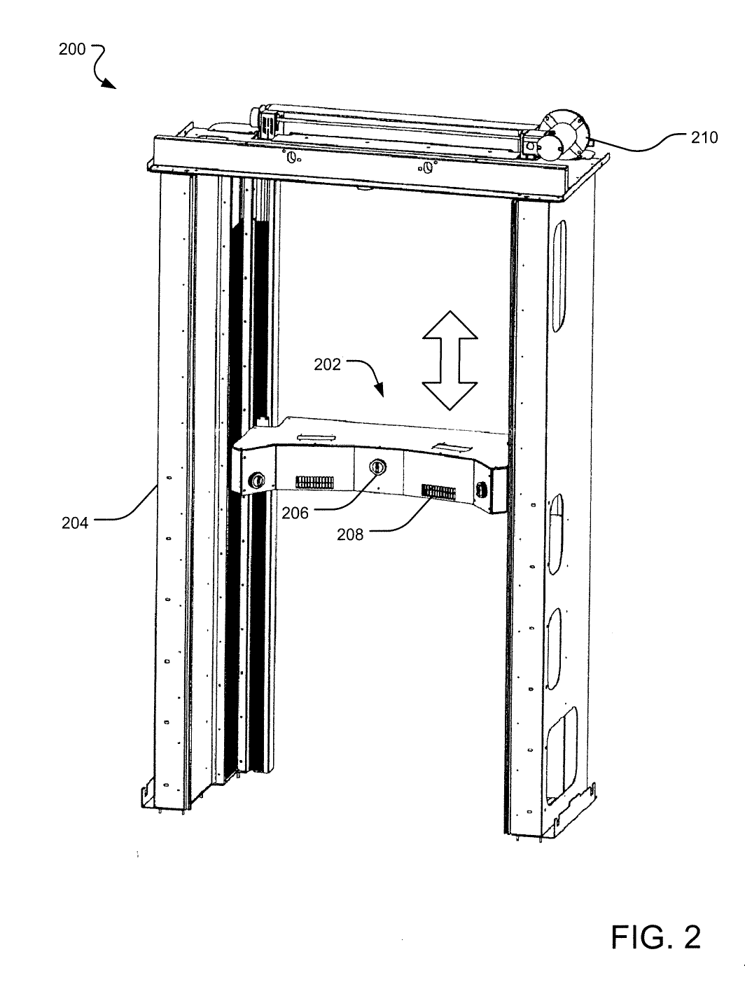

As described below with respect to FIGS. 2-4, one or more sensors 114 on the sunless tanning device 104 collect operational and usage data. Each of the sunless tanning devices 104 includes memory 116 for storing data received from the sensors 114, a unique serial number associated with the sunless tanning device 104, and instructions executable by a processor 118, for example, to execute commands received by the administrator 102 and/or the client 108 and to send the operational and usage information to the administrator 102, the client 108, and/or the database 112. The information is linked to the unique serial number to identify the specific sunless tanning device 104 with which the information is associated. The unique serial number may be registered via the cloud server 110 and associated with the client 108 upon installation of the sunless tanning device 104.

The sunless tanning device 104 records information from the sensors 114 in the memory 116 for sending to the administrator 102, the database 112, and/or the client 108. In one implementation, the sunless tanning device 104 sends the information linked with the unique serial number automatically at predetermined intervals. For example, the sunless tanning device 104 may send the information at least once per day and as often as once every minute. The sunless tanning device 104 may send operational information at different intervals than usage information. For example, usage information (e.g., details and data from the sensors 114 relating to use) may be sent after each session (i.e., use by one customer), and operational information (e.g., details and data collected from the sensors 114 relating to the parameters of the hardware of the sunless tanning device 104) may be sent less frequently. In another implementation, the sunless tanning device 104 sends the information and unique serial number upon command from the administrator 102 and/or the client 108. The sunless tanning device 104 may send the information upon receipt of the command or at a later time specified by the command. For example, the external data network 106 may balance the load of the communications received from the various sunless tanning devices 104 by scheduling when each of the sunless tanning devices 104 will send information via the cloud server 110. In still another implementation, the sunless tanning device 104 includes a button to manually command the sunless tanning device 104 to send the information to and receive information from the external data network 106. The client 108 or an on-site representative of the administrator 102 may use the manual command to aid in diagnostics or to ensure that the administrator 102 has current information for the sunless tanning device 104.

In the event that the sunless tanning device 104 is unable to connect to the external data network 106 (e.g., due to a power outage or blown fuse, the sunless tanning device 104 being disconnected from the external network 106, or other communication or power losses), the memory 116 stores the information to send when a connection is established. If the external data network 106 attempts to connect with the sunless tanning device 104 and connection cannot be established or if the sunless tanning device 104 fails to send information as scheduled, an error event is recorded in the database 112 with the unique serial number associated with the sunless tanning device 104. Other communication errors associated with the sunless tanning device 104 may also be stored in the database 112. For example, if the external data network 110 receives information associated with an unregistered unique serial number, an error event is recorded in the database 112. Further, an error event is recorded in the database 112 if information received from the sunless tanning device 104 is corrupted or incorrectly formatted. Other communication errors are additionally contemplated, including, but not limited to, errors relating to issues with the hardware of the sunless tanning device 104 and errors relating to issues with the connection of the sunless tanning device 104 to the external data network 106. Information associated with an error event, such as operational and usage information may additionally be recorded in the database 112 when an error event is recorded. Further, the administrator 102 and/or the client 108 may manually enter information associated with an error event or manually create an error event in the database 112

In one implementation, when an error event is recorded in the database 112, a support ticket is created for the administrator 102 to review. The support ticket may be ranked in terms of priority depending on the nature of the error. Support tickets are assigned to one or more representatives of the administrator 102 to resolve and close. The support ticket includes, without limitation, a current status, history, and assigned tasks. The support ticket may further include notes manually entered by the representatives with respect to the support ticket. Representatives update the status of the support ticket until the support ticket is closed. If there are no updates to a support ticket over a predetermined time, a notification (e.g., an email, push notification, an alert, etc.) is sent to the representative for follow up. In some implementations, support tickets and associated information is hidden from the clients 108. In other implementations, the clients 108 may track and/or update support tickets associated with the sunless tanning devices 104.

In addition to communication errors (e.g., power issues, WLAN issues, IP address issues, etc.), support tickets are created for hardware related issues. As described in detail with respect to FIGS. 2-4, the sensors 114 collect data relating to the hardware components of the sunless tanning device 104, and the cloud server 110 receives the data, which is then segregated and stored in the database 112. If the client 108 notifies the administrator 102 that one of the sunless tanning devices 104 is experiencing a problem, a support ticket may be created. Additionally, the system 100 monitors and analyzes the operational parameters of the sunless tanning devices 104, and if the data indicates that some or all of the sunless tanning devices 104 are experiencing a similar problem or there may be a problem in the future, a support ticket may be automatically created, or the system 100 may prompt the administrator 102 to create a support ticket. For example, if the sunless tanning devices 104 in one geographic location are all experiencing a similar problem, it may indicate that the climate of that location is impacting the performance of the sunless tanning devices 104. Further, if the sunless tanning devices 104 that are experiencing a similar problem were all installed by the same person or entity, it may indicate that the problems are the result of improper installation. Similarly, if the sunless tanning devices 104 experiencing a similar problem all contain a component supplied from the same supplier or from the same batch, it may indicate there is a workmanship issue with the component. Additionally, if all the sunless tanning devices 104 controlled by one of the clients 108 are experiencing the same problem, it may indicate misuse by the client 108.

To resolve the support ticket, the administrator 102 may remotely analyze the data associated with the unique serial number for the sunless tanning device 104 to determine what may be causing the problem. The remote analysis significantly reduces or eliminates the need of the administrator 102 to rely on information supplied by the client 108 when diagnosing a problem with the sunless tanning device 104. Accordingly, the time that the sunless tanning device 104 is inoperative is reduced, and the time involved in a representative of the administrator 102 traveling to the client 108 to diagnose and repair the sunless tanning device 104 is reduced. For example, the information obtained via the cloud servers 110 may allow the representative to diagnose the problem with the sunless tanning device 104 remotely, so the representative is able to make one trip to the client 108 to repair the sunless tanning device 104. If possible, the representative may remotely instruct the client 108 how to resolve the problem with the sunless tanning device 104. Further, the administrator 102 may use the information obtained via the cloud servers 110 to determine if the problem the client 108 is experiencing is due to a malfunction of the sunless tanning device 104 or due to misuse (e.g., use outside the suggested operational parameters) or lack of proper maintenance by the client 108. For example, due to their properties, many chemical compositions are designed for a specific type of sunless tanning device. Use of the wrong chemical composition may corrode portions of the sunless tanning device 104, clog the nozzles of the sunless tanning device 104, or otherwise damage the sunless tanning device 104. Data collected from the sensors 114, usage information, consumable status information (e.g., when the correct chemical composition was last ordered), and other information received via the cloud servers 112 allows the administrator 102 to determine, with a reasonable degree of certainty, whether a problem with the sunless tanning device 104 was caused by misuse by the customer 108.

If the diagnostic and/or usage information indicates that the sunless tanning device 104 is operating outside of suggested parameters or is experiencing a problem, the administrator 102 can remotely adjust the operational parameters of the sunless tanning device 104 via the cloud servers 110. In one implementation, the operational parameters of the sunless tanning device 104 are automatically adjusted to conform to suggested parameters. In another implementation, a representative of the administrator 102 remotely adjusts the operational parameters in response to a prompt received by the administrator 102. Further, the operational parameters of the sunless tanning devices 104 may be remotely adjusted based on customer preferences. For example, when a customer checks-in with the client 108 to use a sunless tanning device 104, the customer identification is linked with the unique serial number of the sunless tanning device 104 the customer will be using. The customer's preferences are retrieved, and a command is sent to the sunless tanning device 104 to adjust the operational parameters of the sunless tanning device 104 in accordance with the customer's preferences. Customer preferences are stored in the database 112 and/or a database controlled by the client 108. Examples of operational parameters of the sunless tanning devices 104 that may be remotely adjusted are described with respect to FIGS. 2-4. In some implementations, the client 108 has either direct access or access via the cloud servers 110 to remotely adjust the operational parameters of the sunless tanning devices 104. Additionally, the client 108 has either direct access or access via the cloud servers 110 to operate the sunless tanning devices 104, for example, to start and stop sessions, to control the details of those sessions (e.g., the length, the color darkness, whether to add a bronzer or a moisturizer, etc.), or to lock the sunless tanning device 104 from operation for safety reasons.

In one implementation, one or more infrared (IR) sensors are included in the sensors 114. The one or more IR sensors detect the presence of a body part of a customer in an unsafe region of the sunless tanning device 104. For example, if a customer passes out during a session, the one or more IR sensors, alone or in combination with other types of sensors in the sensors 114, detect the potential safety hazard. The sunless tanning device 104 sends the usage and operational parameters, including data collected from the sensors 114, to the administrator 102 via the cloud servers 110. The system 100 analyzes the information and identifies the potential safety hazard. In one implementation, in response, the administrator 102 sends a command to the sunless tanning device 104 to lockdown. The command may also include instructions for the sunless tanning device 104 to notify the customer via voice message, visual message, or other message that help is on the way. The administrator 102 sends an alert to the client 108 with which the sunless tanning device 104 is registered that one of their customers needs help. Additionally or alternatively, the data from the sensors 114 may be sent to the client 108 directly or via the cloud servers 110 to identify and respond to the potential safety hazard. In another implementation, the processor 118 analyzes the data received by the sensors 114, locks down the sunless tanning device 104, and sends an alert to the administrator 102 via the cloud servers 110 and/or to the client 108 either via the cloud servers 110 or directly. After the safety hazard has been cleared, the administrator 102 and/or the client 108 may remotely or manually on-site restart the sunless tanning device 104. In the alternative, the sunless tanning device 104 may sense using the sensors 114 when the safety hazard has been cleared and resume operation.

As described herein, the unique serial number of each sunless tanning device 104 is associated with the client 108, for example, through registration. Accordingly, the administrator 102 may remotely monitor and manage the sunless tanning devices 104 to meet the needs of the client 108. For example, the sensors 114 may monitor levels of the consumables to determine when one of the sunless tanning devices 104 will be out of a consumable. The system 100 may then prompt the administrator 102 to send a reminder to the client 108, directly notify the client 108 to replenish the consumable, or automatically order and ship replacement consumables. In one implementation, the system 100 monitors the consumable levels as they correlate to ordering history to predict when the consumables for one of the sunless tanning devices 104 will be low. Further, the system 100 may monitor the usage information associated with each of the sunless tanning machines 104 controlled by the client 108 to provide billing and payment tracking services. In one implementation, the system 100 monitors the usage of each of the sunless tanning devices 104 controlled by the client 108 and automatically charges the client 108 once a day for the sessions that day. The client 108 then does not have to worry about keeping track of invoices and payments. In another implementation, the system 100 tracks the usage to submit regular invoices to the client 108. The administrator 102 and/or the client 108 track the invoice, balance, and payment status via the cloud servers 110.

If the client 108 fails to pay an invoice, the administrator 102 may remotely evict the sunless tanning device 104 (i.e., prevent any use of the sunless tanning device 104). In one implementation, the administrator 102 sends a command to the sunless tanning device 104 to lockdown. The processor 118 receives the command and prevents the sunless tanning device 104 from operating. In another implementation, a representative of the administrator 102 may manually press a button or input a code that is unique to the individual sunless tanning device 104 to command the sunless tanning device 104 to lockdown. The eviction status of the sunless tanning device 104 is communicated via the cloud servers 110 and stored in the database 112. The eviction status may be displayed on the sunless tanning device 104 and/or on interfaces of the client 108.

The administrator 102 can predetermine how long after non-payment of an invoice before the sunless tanning device 104 is evicted. In one implementation, the system 100 automatically evicts the sunless tanning device 104 after the predetermined time. The system 100 may analyze the payment history or other information to determine a suggested time for automatic eviction. For example, if the client 108 is consistently behind in payments, the system 100 may suggest eviction relatively quickly after a non-payment. However, if the client 108 misses one payment and the payment is not long overdue, the system 100 may suggest a longer time until initiating eviction. In another implementation, the system 100 prompts the administrator 102 to evict the sunless tanning device 104. By prompting the administrator 102, unforeseen circumstances that may have contributed to an unpaid invoice may be taken into account and give the client 108 the opportunity to pay the bill without losing use of the sunless tanning device 104. Further, if the sunless tanning device 104 is wrongly evicted or the client 108 pays an outstanding invoice, the administrator 102 may remotely restore the sunless tanning device 104 for use by sending a command via the cloud servers 110. Alternatively, a representative of the administrator 102 may input the unique code manually on-site to restore the sunless tanning device 104. Upon receipt of the command via the cloud servers 110 or manually, the processor 118 enables the sunless tanning device 104 for use.

In one implementation, the system 100 monitors and manages usage information to provide marketing information to the clients 108. For example, the system 100 may track the number of sessions per day and the number of sessions for each of the sunless tanning devices 104. Based on the information, the clients 108 can determine peak days or seasons, locations that have more business than others, peak times during the day, which type of the sunless tanning devices 104 is the most popular, and what parameters of the sunless tanning devices 104 (e.g., which chemical composition) is the most popular. The clients 108 can then focus their marketing efforts on those days, seasons, times, and parameters. Alternatively, the clients 108 can focus their marketing and promotional efforts on those days, seasons, times, and parameters where business is slower to increase revenues.

Similarly, the clients 108 may link their individual customers to the unique serial number of the sunless tanning device 104 during a session by each customer. By linking customer information with the unique serial numbers, the system 100 tracks the dates and times of sessions by a customer, details of those sessions, such as the chemical composition used (e.g., color darkness, use of a bronzer, use of a moisturizer, etc.), whether promotional materials were used in connection with a session, whether the customer has a membership, and any other relevant customer information. The clients 108 may use the customer information, without limitation, for billing purposes and marketing and promotional purposes.

The information collected and organized, as described herein, may be presented in a graphical user interface, a data readout, a data stream, or a print out. In one implementation, the information is organized and displayed on a collection of web pages. The home page provides an overall summary of the status of the sunless tanning devices 104 and the clients 108. For example, the home page may list recently updated key operational and usage information for the sunless tanning devices 104, recently updated or created support tickets, recent payments by the clients 108, recent orders placed, recent invoices submitted to the clients 108, and recent alerts. In one implementation, the statuses and updates are displayed graphically for quick review by the administrator 102. For example, the operational parameters of the sunless tanning devices 104 may be displayed as red, yellow, and green lights. If a component of one of the sunless tanning devices 104 is functioning within the suggested operational parameters, the light is green, and if the component is functioning outside or close to outside of those parameters, the light is yellow or red. Similarly, if one of the sunless tanning devices is low on a consumable (e.g., the chemical composition), the light is red.

The collection of web pages may further include, without limitation, a client information page, a people page, a membership page, a sunless tanning device page, a product page, an orders page, an invoices page, a payments page, a raw data page, an error page, an eviction status page, and a support ticket page. Each of the pages may include a comments section for the administrator 102 and/or the client 108 to enter information pertaining to an entry on one of the pages.

The client's page displays information relating to the clients 108. For example, contact information, billing information (e.g., billing contact, billing address, etc.) may be included on the clients page. The clients page may also include information about individual customers associated with the clients 108. The people page displays information relating to persons associated with the clients 108 that have access to the system 100 or who are representatives of the clients 108. The people page may display, for example, the names of the people, which of the clients 108 they are associated with, their role, and their access level to the system 100. The membership page displays information relating to the administrator 102. For example, the membership page includes personnel names, roles, and access levels to the system 100. Roles may include, without limitation, administrator, supervisor, tech support, customer service representative, and guest.

The sunless tanning devices page displays information relating to the sunless tanning devices 104. For example, initial registration information, location information, serial numbers, IP addresses, configuration information, device type, and other data points for each of the sunless tanning devices 104 may be included on the sunless tanning devices page.

The product page displays information about the status of consumables associated with the sunless tanning devices 104. For example, the product page displays information regarding the pool of available consumables and their cost. The consumables may include, without limitation, the chemical compositions, filters, disposable suits, barrier creams, and other replenishment items. The product page may further include information relating to any orders placed, invoices submitted, and payments received for consumables. The orders page displays information relating to orders by or for the clients 108. The orders page includes, for example, the product, the quantity, whether the order was automatically generated or initiated by the client 108 or the administrator 102, who is responsible for fulfilling the order, and the status of the order.

The invoices page displays information relating to any invoices submitted to the clients 108. For example, the invoices page may include the date an invoice was submitted, the client associated with the invoice, the amount, the due date, and the status of the invoice. The invoices page may include information for invoices relating to use of the sunless tanning devices 104 and/or invoices for products. Similarly, the payments page displays information relating to the status of payments. The payments are credited against the invoices, and the payments page includes, for example, the date of a payment, the amount, and the invoice reference.

The raw data page displays usage and operational information relating to the sunless tanning devices 104. For example, the raw data page may include, without limitation, data collected by the sensors 114, the amount of sessions, session details, the status of consumables, and any problems with the sunless tanning devices 104. Information displayed on the raw data page may be used to anticipate orders and to automatically bill the clients 108.

The error page displays information relating to error events, as described herein. The errors page may include, for example, the nature of the error, the sunless tanning device 104 and/or the client 108 associated with the error, the representative of the administrator 102 assigned to resolve the error, the priority of the error, and the status of the error.

The eviction status page displays information relating to the eviction of any of the sunless tanning devices 104. For example, the eviction status page may include, without limitation, the serial numbers of the sunless tanning devices 104 that are currently, will be, or have previously been evicted, the reason for eviction, the identification of the client 108, the date or projected date of eviction, and communications with the client 108 regarding eviction.

Finally, the support ticket page displays information relating to support tickets, as described herein. For example, the support ticket page may include, without limitation, date of initial report, the nature of the issue(s), priority of resolving the issue(s), the person(s) assigned to resolving the issue(s), and the status of the support ticket.

FIGS. 2-4 illustrate components 200, 300, and 400 of an example implementation of the sunless tanning device 104 that may be remotely monitored and managed by the system 100. As described herein, the sensors 114 collect usage and operational information of the sunless tanning device 104. Based on this information, the administrator 102 and/or the clients 108 can adjust the parameters of the sunless tanning device 104 between or during sessions. The adjustments may be made, for example, to conform to the preferences of the clients 108 and/or an individual customer, to update the sunless tanning devices 104, and/or to address problems with the sunless tanning devices 104.

As shown in FIG. 2, one implementation of the sunless tanning device 104 includes the components 200. A bar 202 moves vertically along a frame 204. Positioned on the bar is a plurality of nozzles 206, which are connected to a plurality of pumps (not shown). In one implementation, the sunless tanning device 104 includes three nozzles and four pumps. However, other quantities of nozzles and pumps are contemplated. The atomized chemical composition is sprayed from the nozzles 206 and coated onto all or part of the human body. In one implementation, the sunless tanning device 104 is a high volume low pressure (HVLP) system. A high volume of air atomizes the chemical composition and propels it at a low pressure through the nozzles 206 onto the human body. Accordingly, the pressure of the pumps impacts the atomization of the chemical composition.

The sensors 114 include a pressure sensor (e.g., a transducer) that measures the pressure in each of the pumps and sends the pressure readings for each of the pumps to the administrator 102 via the cloud servers 110. The administrator 102 analyzes the data and may adjust the pressure of one or more of the pumps to improve atomization and application of the chemical composition (e.g., reduce overspray, reduce consumption of the chemical composition, increase the proportion of the chemical composition reaching the body, and increase the uniformity of the application of the chemical composition), to satisfy customer preferences, and to resolve any problems with the nozzles 206 or the pumps resulting from pump pressure. Further, data gathered from the pressure sensor may indicate one the nozzles 206 is clogged or the client 108 is using the wrong chemical composition in the sunless tanning device 104.

Further, the sensors 114 may include additional sensors relating to the positioning of the nozzles 206 and the volume of the chemical composition that is sprayed through the nozzles 206. For example, the sensors 114 may include one or more sensors for collecting data that may be used to determine whether the spray from the nozzles 206 is being uniformly applied over the customer and/or to determine the height of the customer and the position of the customer relative to the bar 202. Based on this information, the administrator 102 may adjust the positioning of the nozzles 206 on the bar 202, the separation between each of the nozzles 206, and the angle of the nozzles 206. Additionally, the sensors 114 may include a sensor for measuring the volume of the chemical composition sprayed from each of the nozzles 206 at each position of the bar 202. The volume of the chemical composition sprayed impacts the shape of the spray as it leaves the nozzles 206 and the uniformity of the application. For example, a higher volume of the chemical composition creates a tighter fan shaped spray from the nozzles 206, and a lower volume of the chemical composition creates a wider fan shaped spray from the nozzles 206. Further, the administrator 102 may adjust the pressure and volume to ensure a constant volume of the chemical composition is applied to the customer. For example, the sunless tanning device 104 may apply the chemical composition at a higher pressure when the bar 202 is at the top of the sunless tanning device 104 and a lower pressure when the bar 202 is near the bottom.

In one implementation, the bar 202 includes one or more heaters 208 to dry the customer during and/or after application of the chemical composition and to ensure the customer remains at a comfortable temperature. The sensors 114 include one or more temperature sensors, which may be positioned at various locations in the sunless tanning device 104, to measure the temperature in the sunless tanning device 104. The administrator 102 and/or the client 108 may analyze the temperature data and, if necessary, adjust the temperature of the heaters 208 to ensure the customer is comfortable during a session. In some implementations, the positions of the heaters 208 are adjustable to direct the heated air at the customer. In another implementation, the sensors 114 includes a current monitor connected to a motor in the heaters 208 to measure the current output of the motor, which indicates whether the heaters 208 are functioning properly.

A motor 210 is operably connected to the bar 202 to move the bar 202 vertically along the frame 204. In one implementation, the sensors 114 includes a sensor for reading the speed of the motor 210. The motor 210 controls the speed at which the bar 202 moves. The speed the motor 210 moves affects the volume of chemical composition that is sprayed on the customer, which, for example, results in tans of varying darkness. As described herein, the pressure of the pumps affects the atomization of the chemical composition, and proper atomization is important to whether the chemical composition is evenly applied to the customer. Accordingly, rather than varying the pump pressure or changing the concentration of the chemical composition to provide different levels of tan darkness, the speed of the motor 210, and thus the bar 202, is varied. In one implementation, the speed of the bar 202 is predetermined according to different levels of tan darkness. For example, a level one tan may be correlated to a speed of six seconds for the bar 202 to move from the top of the frame 204 to the bottom; a level two tan may be correlated to a speed of seven seconds, and; a level three tan may be correlated to a speed of eight seconds. However, other speeds are contemplated, and the speed may be remotely or manually adjusted.

The system 100 may use the speed of the bar 202 to determine what combination of the chemical composition customers of the client 108 are using in their sessions. The client 108 may then use this information to track customer satisfaction. Each person's skin reacts differently to the chemical composition. As such, the client 108 may use session information to determine whether a customer is using the correct combination of the chemical composition. Further, if many customers are not satisfied with a particular combination of the chemical composition, the administrator 102 and/or the client 108 may adjust the chemical composition or the operational parameters of the sunless tanning device 104. Additionally, by tracking the speed of the motor 210 to determine the level of tan darkness, the clients 108 can identify the level that is most popular and focus their marketing efforts accordingly. Similarly, the sensors 114 may include an odometer for measuring the number of times the bar 202 moves from the top of the frame 204 to the bottom. The odometer may be used by the administrator 102 for billing to track the amount of sessions and for ordering to predict when consumables need to be replaced.

As described herein, the sensors 114 may include one or more IR sensors to detect potential safety hazards. In one implementation, the sunless tanning device 104 includes one IR sensor on the base of the sunless tanning device 104 and one IR sensor on an underside of the bar 202 to detect ingress by the customer during movement of the bar 202. If all or a portion of the customer's body passes under the bar 202 during movement, the system 100 will identify the potential safety hazard. In response, the system 100 may command the sunless tanning device 104 to stop and reverse the bar 202. In one implementation, the odometer may also be used to identify potential safety hazards. For example, if the bar 202 begins moving and fails to reach the bottom of the frame 204 in the predetermined time correlating to the level of tan darkness, the system 100 recognizes a potential safety hazard. Further, in another implementation, the motor 210 may include a load sensor, and if a high current is detected, a possible safety hazard is identified.

In one implementation, before the bar 202 begins moving in each sequence in a session, a voice prompt provides the customer verbal instructions. There is a time delay between each voice prompt. In some implementations, the time delay and the content of the voice prompt is remotely or manually adjustable by to tailor the message to the client 108. For example, the client 108 may include a promotional or individualized message at the beginning of a session. Additionally, the language spoken during the voice prompt may be changed. Further, the audio level of the voice prompt may be adjustable during or between sessions.

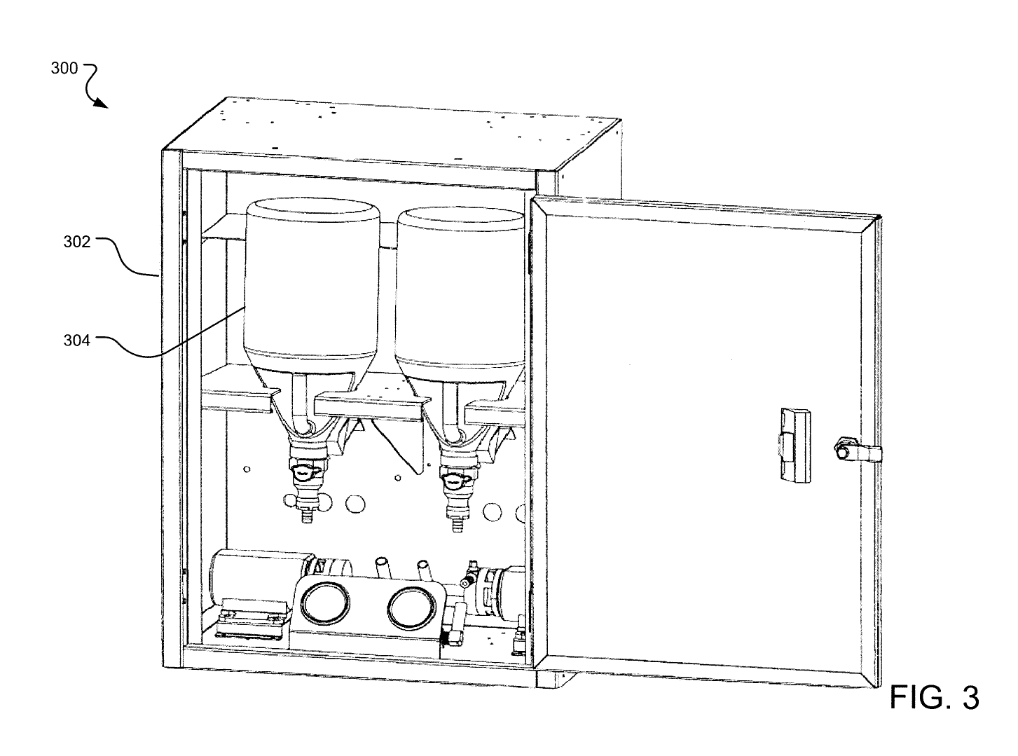

As can be understood from FIG. 3, the components 300 include a housing 302 for one or more containers 304 holding the chemical composition. Often, it is challenging for the clients 108 to quickly and easily change the containers 304 while tracking the status of the chemical composition. To ensure customer satisfaction, the level of fluid in the containers 304 should be monitored to prevent a “dry spray” (i.e., a spray where little to no volume of the chemical composition is propelled from the nozzles 206 onto a customer).

The system 100 remotely monitors and manages the status of the fluid levels in each of the containers 304 to identify high and low fluid events. In one implementation, the sensors 114 include one or more capacitors on the containers 304 corresponding to different capacity gradients of the containers 304 a range of fluid levels to determine whether the containers 304 are full or close to low. In another implementation, the odometer is used in connection with ordering information to monitor the fluid level of the containers 304 based on the number of sessions since the containers 304 were last replaced. Specifically, the system 100 correlates the number of sessions between when a container 304 is ordered and placed in the sunless tanning device 104 and when the container 304 is replaced to predict when the fluid in the container 304 will be low. In still another implementation, the sensors 114 include sensors that are in direct communication with the fluid in the containers 304 to measure fluid levels. Other fluid level sensors are also contemplated.

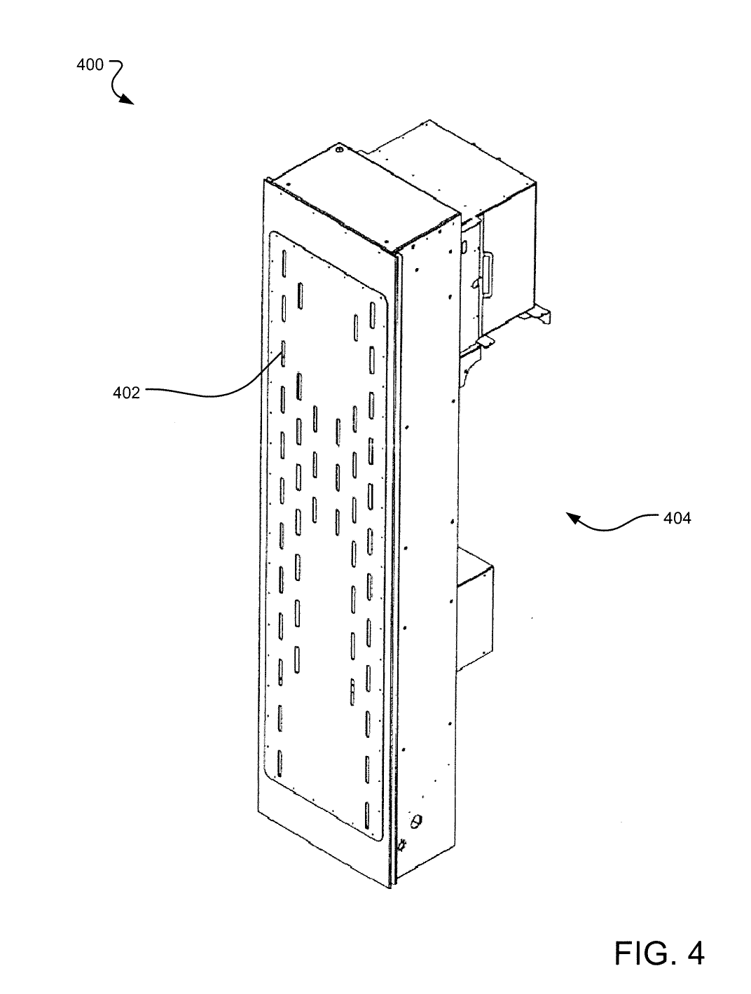

As shown in FIG. 4, the components 400 include a plurality of holes 402 that draw air out of the sunless tanning device 104 using an exhaust tower assembly 404. The extent of air filtering of the sunless tanning device 104 during a session impacts the quality of the session and customer satisfaction. There is a balance between leaving too much spray in the air during a session and drawing the spray out of the sunless tanning device 104 too quickly. If the spray remains in the air too long during a session, the customer may be unsatisfied with being surrounded by the spray. Additionally, if the spray is removed through the holes 402 too quickly, the customer may not receive an even coating. Accordingly, in one implementation, the sensors 114 include one or more airflow sensors to determine if exhaust tower assembly 404 is clogged or if a filter needs to be replaced. The system 100 may analyze and monitor airflow of the sunless tanning devices 104 and remotely adjust the parameters of the exhaust tower assembly 404 such that the sunless tanning devices 104 have an airflow that causes the spray to adhere to the customer better and that is more comfortable for the customer.

In addition to the components 200, 300, and 400, the sunless tanning device 104 may include a cleaning system, which automatically washes the sunless tanning device 104 after a session. In one implementation, the length of the wash and the delay before initiating the wash is adjustable to ensure a proper and practical wash is completed between sessions. For example, water pressure varies across geographic regions. The sensors 114 may include a sensor for measuring the water pressure. The administrator 102 and/or the clients 108 may use water pressure data to remotely or directly adjust the wash time accordingly. In one implementation, the sensors 114 include a sensor associated with a sump pump for removing accumulated water from the sunless tanning device 104. The sensor may be used to determine whether there is a clog preventing removal of accumulated water.

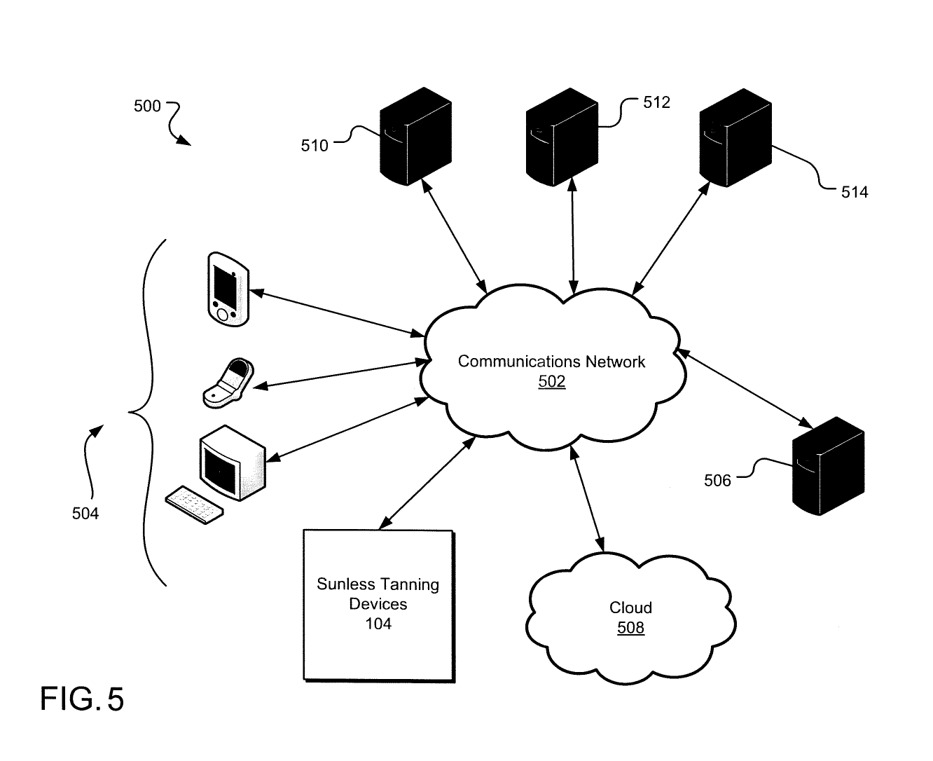

FIG. 5 illustrates an example network environment 500 for implementing the system 100, as described herein. As depicted in FIG. 5, a communications network 502 (e.g., the Internet) is used by one or more computing or data storage devices for implementing the system 100 for remotely monitoring and managing the sunless tanning devices 104. In one implementation, the sunless tanning devices 104 and one or more user devices 504 are communicatively connected to the communications network 502. Examples of the user devices 504 include a personal computer, a lap top, a smart-phone, a tablet or slate (e.g., iPad), a multimedia console, a gaming console, a Personal Digital Assistant (PDA), a set top box, etc. The administrator 102 and/or the clients 108 may access the system 100 using the user devices 504.

A server 506 hosts the system 100. In one implementation, the server 506 also hosts a website or an application that users, including but not limited to the clients 108 and the administrator 102, visit to access the system 100. The server 506 may be one single server, a plurality of servers with each such server being a physical server or a virtual machine, or a collection of both physical servers and virtual machines. In another implementation, a cloud 508 hosts one or more components of the system 100. The sunless tanning devices 104, the user devices 504, the server 506, the cloud 508, and other resources connected to the communications network 502 may access one or more of servers 510, 512, and 514 for access to one or more websites, applications, web services interfaces, etc. that are used to remotely monitor and manage the sunless tanning devices 104. In one implementation, the server 506 also hosts a search engine that the system 100 uses for accessing and modifying information used to remotely monitor and manage the sunless tanning devices 104 and the clients 108.

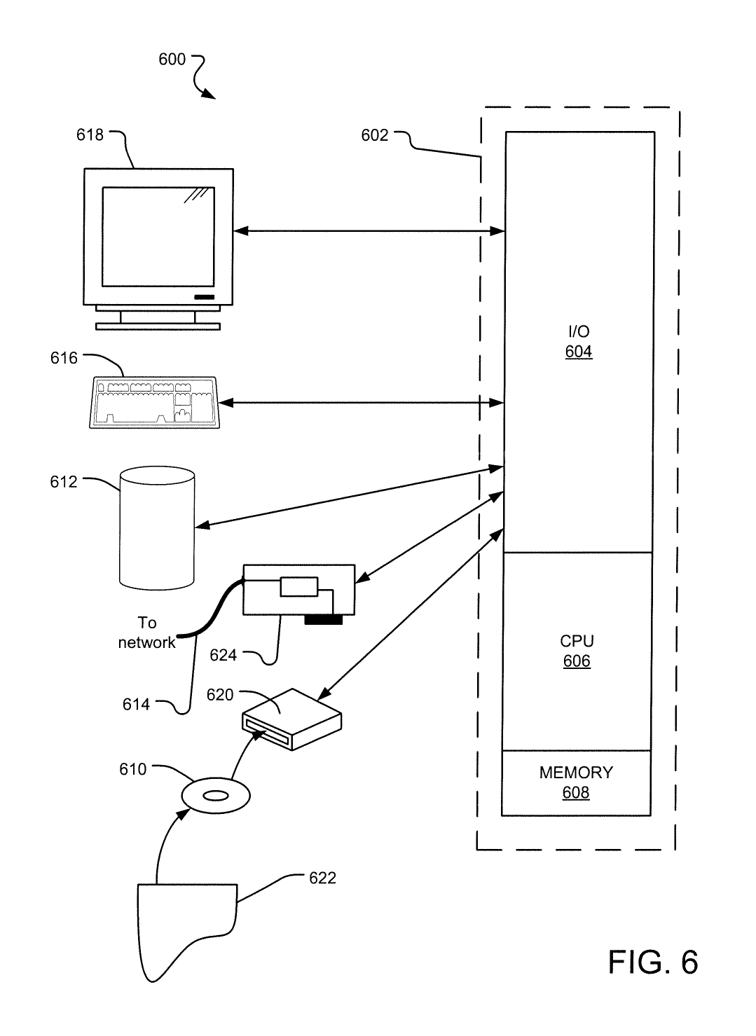

FIG. 6 illustrates an example computer system 600 that may be useful in implementing the presently disclosed technology. A general purpose computer system 600 is capable of executing a computer program product to execute a computer process. Data and program files may be input to the computer system 600, which reads the files and executes the programs therein. Some of the elements of a general purpose computer system 600 are shown in FIG. 6 wherein a processor 602 is shown having an input/output (I/O) section 604, a Central Processing Unit (CPU) 606, and a memory section 608. There may be one or more processors 602, such that the processor 602 of the computer system 600 comprises a single central-processing unit 606, or a plurality of processing units, commonly referred to as a parallel processing environment. The computer system 600 may be a conventional computer, a distributed computer, or any other type of computer, such as one or more external computers made available via a cloud computing architecture. The presently described technology is optionally implemented in software devices loaded in memory 608, stored on a configured DVD/CD-ROM 610 or storage unit 612, and/or communicated via a wired or wireless network link 614 on a carrier signal, thereby transforming the computer system 600 in FIG. 6 to a special purpose machine for implementing the described operations.

The I/O section 604 is connected to one or more user-interface devices (e.g., a keyboard 616 and a display unit 618), a disc storage unit 612, and a disc drive unit 620. Generally, the disc drive unit 620 is a DVD/CD-ROM drive unit capable of reading the DVD/CD-ROM medium 610, which typically contains programs and data 622. Computer program products containing mechanisms to effectuate the systems and methods in accordance with the presently described technology may reside in the memory section 604, on a disc storage unit 612, on the DVD/CD-ROM medium 610 of the computer system 600, or on external storage devices made available via a cloud computing architecture with such computer program products, including one or more database management products, web server products, application server products, and/or other additional software components. Alternatively, a disc drive unit 620 may be replaced or supplemented by a floppy drive unit, a tape drive unit, or other storage medium drive unit. The network adapter 624 is capable of connecting the computer system 600 to a network via the network link 614, through which the computer system can receive instructions and data embodied in a carrier wave. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 600 is connected (by wired connection or wirelessly) to a local network through the network interface or adapter 624, which is one type of communications device. When used in a WAN-networking environment, the computer system 600 typically includes a modem, a network adapter, or any other type of communications device for establishing communications over the wide area network. In a networked environment, program modules depicted relative to the computer system 600 or portions thereof, may be stored in a remote memory storage device. It is appreciated that the network connections shown are examples of communications devices for and other means of establishing a communications link between the computers may be used.

In an example implementation, the computer system 600 includes the database 112, the cloud servers 110, and the sunless tanning devices 104, as described with respect to FIG. 1. The database 112, a plurality of internal and external databases, source databases, and/or data cache on the cloud servers 112 are stored as the memory 608 or other storage systems, such as the disk storage unit 612 or the DVD/CD-ROM medium 610, and/or other external storage devices made available and accessible via a cloud computing architecture. Remote monitoring and management software and other modules and services may be embodied by instructions stored on such storage systems and executed by the processor 602. Some or all of the operations described herein may be performed by the processor 602. Further, local computing systems, remote data sources and/or services, and other associated logic represent firmware, hardware, and/or software configured to control the sunless tanning devices 104. Such services may be implemented using a general purpose computer and specialized software (such as a server executing service software), a special purpose computing system and specialized software (such as a mobile device or network appliance executing service software), or other computing configurations. In addition, one or more functionalities of the system 100 disclosed herein may be generated by the processor 602 and a user may interact with a Graphical User Interface (GUI) using one or more user-interface devices (e.g., the keyboard 516, the display unit 518, and the user devices 504) with some of the data in use directly coming from online sources and data stores.

The implementations described herein may be implemented as logical steps in one or more computer systems. The logical operations of the presently disclosed technology are implemented (1) as a sequence of processor-implemented steps executing in one or more computer systems and (2) as interconnected machine or circuit modules within one or more computer systems. The implementation is a matter of choice, dependent on the performance requirements of the computer system implementing the presently disclosed technology. Accordingly, the logical operations making up the implementations of the presently disclosed technology described herein are referred to variously as operations, steps, objects, or modules. Furthermore, it should be understood that logical operations may be performed in any order, unless explicitly claimed otherwise or a specific order is inherently necessitated by the claim language. Furthermore, one of more portions of the various processes disclosed above may be implemented by software, hardware, firmware or combination thereof.

The above specification, examples, and data provide a complete description of the structure and use of example implementations of the invention. Various modifications and additions can be made to the exemplary implementations discussed without departing from the spirit and scope of the presently disclosed technology. For example, while the implementations described above refer to particular features, the scope of this disclosure also includes implementations having different combinations of features and implementations that do not include all of the described features. Accordingly, the scope of the presently disclosed technology is intended to embrace all such alternatives, modifications, and variations together with all equivalents thereof.

What is claimed is:

1. A method for remotely monitoring and managing a sunless tanning device, comprising the steps of:
a. monitoring the outputs from at least one sensor within a sunless tanning device;
b. collecting information from the sensors;
c. categorizing the information; and,
d. transmitting information associated with a status of the sensors, over a network using a network protocol, to a supervisory monitory system.

2. The method for remotely monitoring of claim 1, further comprising adjusting the operational parameters of at least one of the sunless tanning devices based on the sensor information.

3. The method for remotely monitoring of claim 1, wherein the information collected is usage information.

4. The method for remotely monitoring of claim 1, wherein the information collected is diagnostic information.

5. The method for remotely monitoring of claim 1, wherein the diagnostic information includes liquid fluid levels, volume delivery, pressure, movement of the sunless tanning devices spray bar, exhaust systems, voice prompt systems, or heated air delivery.

6. The method for remotely monitoring of claim 1, further comprising monitoring in real time.

7. The method for remotely monitoring of claim 1, further comprising monitoring over a defined interval for relay of information.

8. The method for remotely monitoring of claim 7, wherein the defined intervals are every 24 hours.

9. The method for remotely monitoring of claim 1, further comprising monitoring the number of cycles completed in order to deliver information on the sunless tanning sessions used.

10. The method for remotely monitoring of claim 1, wherein the information is transmitted using encapsulated communications programs and a standard Internet browser.

11. The method for remotely monitoring from claim 1, wherein the information delivered are alarm conditions, wherein the alarm conditions are transmitted over the network to a supervisory monitoring system, wherein the supervisory monitoring system creates an occurrence vent and relays the occurrence event to a desired location to handle the alarm condition.

12. A computer-readable medium storage media encoding computer-executable instructions for executing on a computer system a computer process for remotely monitoring and managing a plurality of sunless tanning devices, the computer process comprising:
a. capturing usage and diagnostic information from one or more sensors on each of the sunless tanning devices;
b. categorizing the usage and diagnostic information;
c. adjusting the operational parameters of at least one of the sunless tanning devices based on the usage and diagnostic information; and,
d. transmitting usage and diagnostic information to at least one data storage location.

13. A system for remotely monitoring a sunless tanning device comprising;
a. at least one computing device; and
b. instructions executable by the at least one computing device to:
i. collect information from at least on sensor on the sunless tanning device;
ii. capture information from at least one sensor on the sunless tanning device;
iii. categorize information from at least one sensor on the sunless tanning device;
iv. dynamically generate an event tag for the information captured;
v. transmit the event tag to a viewer; and
vi. transmit adjusting operational parameters to a viewer.
